(19) United States
(12) Patent Application Publication
(10) Pub. No.: US 2020/0086851 A1
(43) Pub. Date: Mar. 19, 2020

(54) VEHICLE REMOTE PARKING ASSIST SYSTEMS AND METHODS

(71) Applicant: Ford Global Technologies, LLC, Dearborn, MI (US)

(72) Inventors: Markus Krekel, Wermelskirchen (DE); Ahmed Benmimoun, Aachen (DE); Mike Mould, Leverkusen (DE)

(21) Appl. No.: 16/130,584

(22) Filed: Sep. 13, 2018

(51) Int. Cl. B60W 30/06; B60W 50/14; G06K 9/00; B60W 40/08; E05F 15/40

(52) U.S. Cl. CPC B60W 30/06; B60W 50/14; G06K 9/00838; B60W 2040/0809; E05F 15/40; B60W 2050/143; B60W 40/08

(57) ABSTRACT

Vehicles and methods are disclosed for enabling vehicle occupants to minimize their time outside a vehicle during a remote park-out operation, so as to limit exposure to adverse weather. An example vehicle includes a communication system, doors, sensors, and a processor. The processor is configured to receive an indication of a selected door via the communication system, determine a vehicle path for a remote park-out operation, and, during execution of the remote park-out operation, determine using the sensors that the selected door transitioned from being inaccessible to being accessible.

### TECHNICAL FIELD

The present disclosure generally relates to vehicle remote parking and park-out assistance, and, more specifically, systems and methods to minimize occupant time spent outside the vehicle during a remote park-out operation from a narrow parking space.

### BACKGROUND

Modern vehicles may include the ability to remotely drive themselves with no or only minor control instruction from the user. Some vehicles may even be able to park themselves or return from a parking spot (park out) while an owner or driver watches from either inside or outside the vehicle and provides no or minimal motion control instruction. In these instances, the driver may initiate the remote parking operation, and the vehicle may proceed to carry out the operation using vehicle sensors.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown enabling a driver and other occupants of a vehicle to minimize their time outside a vehicle upon returning to it in a parked position, particularly when the vehicle is parked in a position that makes it difficult for passengers to open the doors and enter the vehicle comfortably. An example disclosed vehicle includes a communication system, doors, sensors, and a processor. The processor is configured to receive an indication of a selected door via the communication system, determine a vehicle path for a remote park-out operation, and during execution of the remote park-out operation, determine using the sensors that the selected door transitioned from being inaccessible to being accessible.

An example disclosed method includes receiving, by a communication system of a vehicle, an indication of a selected door of the vehicle. The method also includes determining a vehicle path for a remote park-out operation. And the method further includes, during execution of the remote park-out operation, determining using sensors of the vehicle that the selected door transitioned from being inaccessible to being accessible.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIGS. 1A-1C illustrate an example vehicle having a single user and performing a remote park-out operation according to embodiments of the present disclosure.

FIGS. 2A-2C illustrate another example vehicle having three users and performing a remote park-out operation according to embodiments of the present disclosure.

FIG. 3 illustrates a block diagram of electronic components of the vehicles of FIG. 1 and FIG. 2.

FIG. 4 illustrates a flowchart of an example method according to embodiments of the present disclosure.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

As noted above, embodiments herein are directed to vehicles, systems, and methods for minimizing the time spent outside of a vehicle when the vehicle is controlled to perform a remote park-out operation. A remote park-out operation may include the vehicle autonomously moving itself from a parking space into a parking lot, road, or other location, to enable the driver and/or other passengers to enter the vehicle before they proceed to their destination. This may be a particularly useful maneuver for a vehicle to perform when it is parked in a narrow parking spot that does not afford the passengers much room to open the doors and enter the vehicle.

In some scenarios in which there is rain, snow, cold temperatures, or other inclement weather, the driver and/or other occupants may wish to minimize their time outside the vehicle when the remote park-out operation is in progress, to avoid waiting outside the vehicle for the full operation to be carried out.

In order to minimize the time a passenger spends outside the vehicle during a remote park-out operation, some examples may include moving the vehicle autonomously from the parking spot to a position in which the driver can comfortably open the door and enter the vehicle. However, where there are additional passengers, particularly children, the elderly, pets, etc., it may not be beneficial to have them wait outside the vehicle while the driver finishes the park-out maneuver.

Some examples of the present disclosure may include initiating the remote park-out operation via a remote computing device, such as a phone, tablet, or other mobile computing device from outside the vehicle. Upon entering a communication range with the vehicle, the user (e.g. driver) may select one or more vehicle doors via a user interface of the remote computing device. This can be done by the remote computing device displaying a scale model of the vehicle, along with selecting the door(s) by tapping, clicking, speaking, or otherwise interacting with the remote computing device.

The vehicle may then begin executing the remote park-out operation by driving along a defined vehicle path. The vehicle may also monitor the distance, position, and orientation of various objects in the environment surrounding the vehicle using one or more vehicle sensors. When the vehicle reaches a position along the vehicle path at which the selected door(s) can be opened without running into the objects in the environment, the vehicle may take an appropriate action. For example, the vehicle may stop moving and execution of the remote park-out operation and automatically open one or more of the selected door(s). The vehicle may also or alternatively transmit an alert to the remote computing device indicating that the selected door(s) is(are) now accessible. Various other actions can be taken as well.

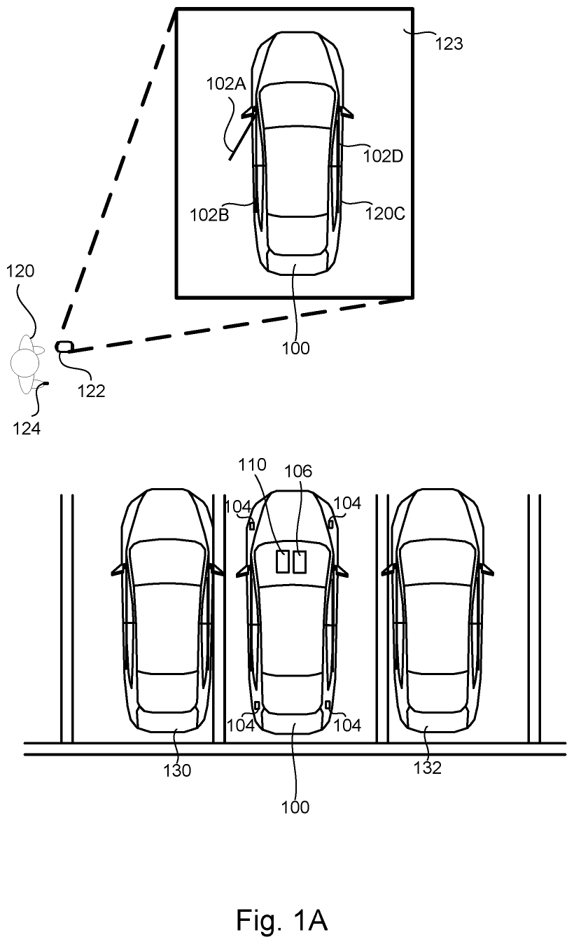

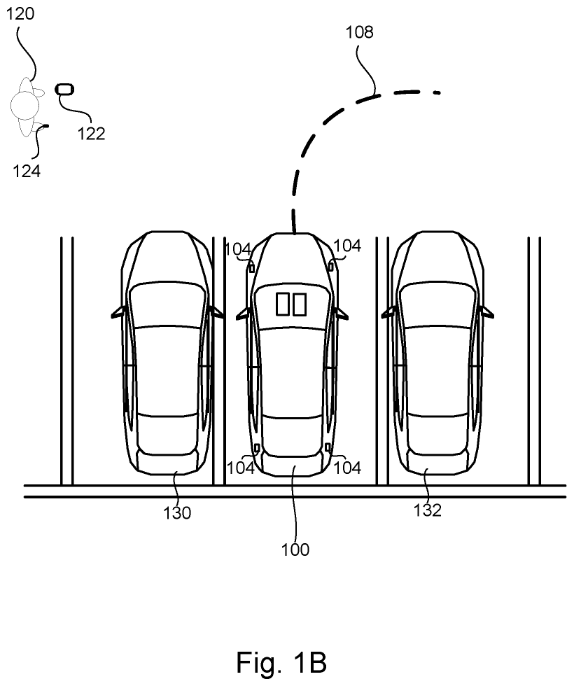

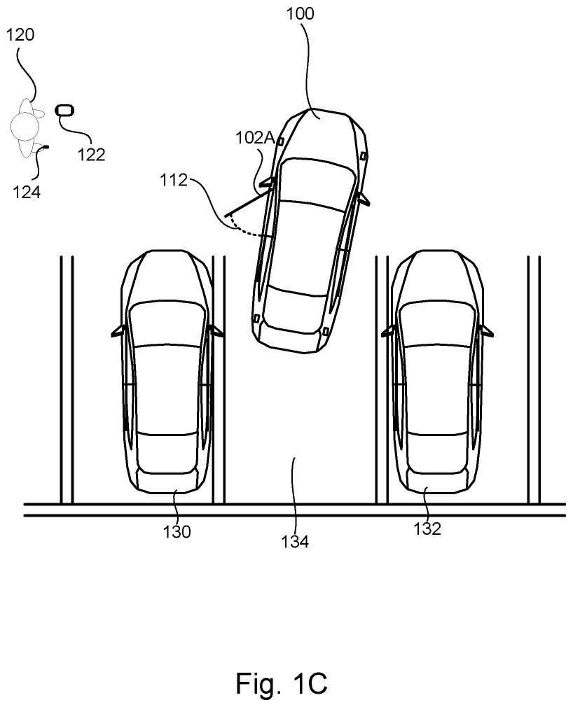

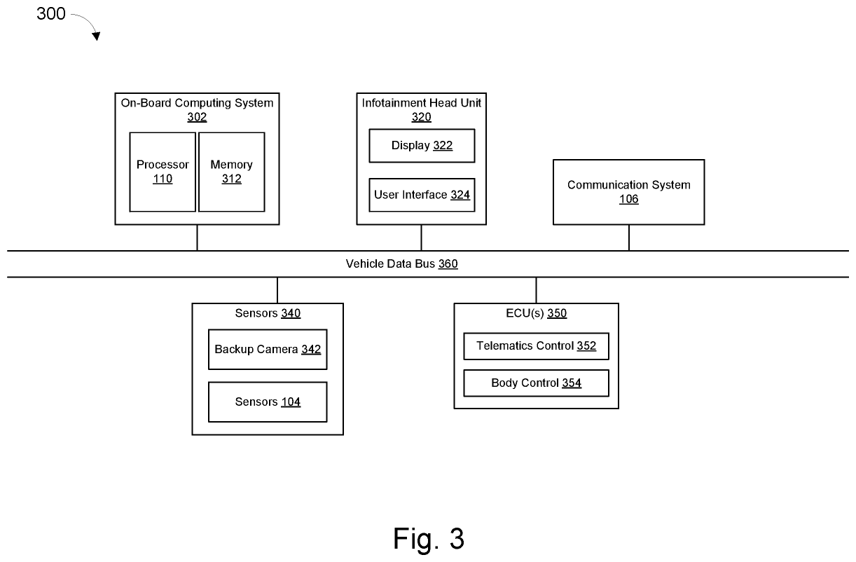

FIGS. 1A-1C illustrate the remote park-out operation process described above when only a single operator 120 is present outside the vehicle. Vehicle 100 may be a standard gasoline powered vehicle, a hybrid vehicle, an electric vehicle, a fuel cell vehicle, or any other mobility implement type of vehicle. Vehicle 100 may be non-autonomous, semi-autonomous, or autonomous. Vehicle 100 includes parts related to mobility, such as a powertrain with an engine, a transmission, a suspension, a driveshaft, and/or wheels, etc. In the illustrated example, vehicle 100 may include one or more electronic components (described below with respect to FIG. 3).

As shown in FIG. 1, vehicle 100 may include one or more components including a communication system 106, a processor 110, sensors 104, and one or more doors 102A-D. In particular, vehicle 100 may include a driver's side front door 102A, as well as one or more other doors such as a passenger's side front door 102D, rear door(s) 102B and 102B, and a trunk or liftgate. Examples disclosed herein are shown with reference to a sedan having four doors and a trunk, however it should be understood that the principles disclosed herein can also apply to other vehicles having other numbers and/or orientations of doors.

Each door may have a particular minimum open door angle, which may refer to the angle at which the door opens to comfortably and safely allow an occupant to exit. This minimum open door angle may be a default value determined or set by a manufacturer, or may be set via input from a user of the vehicle.

In some examples, the minimum open door angle may be determined based on input received by a user via a user interface of vehicle 100. Alternatively, the minimum open door angle may be set by having an operator of the vehicle move the door to a desired open angle, and storing the determined angle as the minimum open door angle for that door.

One or more determinations can be made based on the open door angle, in combination with other values such as the known door length from the pivot point, and other door characteristics. These values can allow the vehicle and/or processor 110 of vehicle 100 to predict a position of the door when opened to the open door angle. This can allow the vehicle to determine whether the vehicle is in a position in which a particular door is accessible or inaccessible, based on whether the door can be opened to the corresponding minimum open door angle.

Vehicle 100 may also include one or more sensors 104, which may be positioned at various places in and around vehicle 100. Sensors 104 may be ultrasonic, radar, video, image, or other types of sensors that are configured to determine the location of objects and obstacles in the environment surrounding vehicle 100. Sensors 104 may be used to determine a distance between the vehicle 100 and the objects in environment, including vehicles 130 and 132 in parking spots adjacent to vehicle 100 when parked as shown in FIGS. 1A-1C.

Information from the sensors may be combined with or used in connection with known door characteristics, such as the door length and shape, to determine whether a given vehicle door is accessible or inaccessible (i.e., whether or not the door can be opened to a minimum open door angle). For instance, the sensor data may be used in connection with known door characteristics such as size and shape to monitor the sides of the vehicle as the vehicle moves. This can allow the vehicle to continuously determine what angle the door can be opened to without running into objects in the environment. In particular examples, the sensor information may be used to determine whether a given door can be opened to a minimum open door angle or not.

Processor 110 of vehicle 100 may be configured to carry out one or more functions or acts such as those described herein. Processor 110 may be part of on-board computing system 302 described with respect to FIG. 3.

In some examples, processor 110 may be configured to receive an indication of a selected door via the communication system 106. The communication system may include one or more antennas, processors, or other components configured to enable wireless or wired communication between the vehicle 100 and another computing device, such as remote computing device 122.

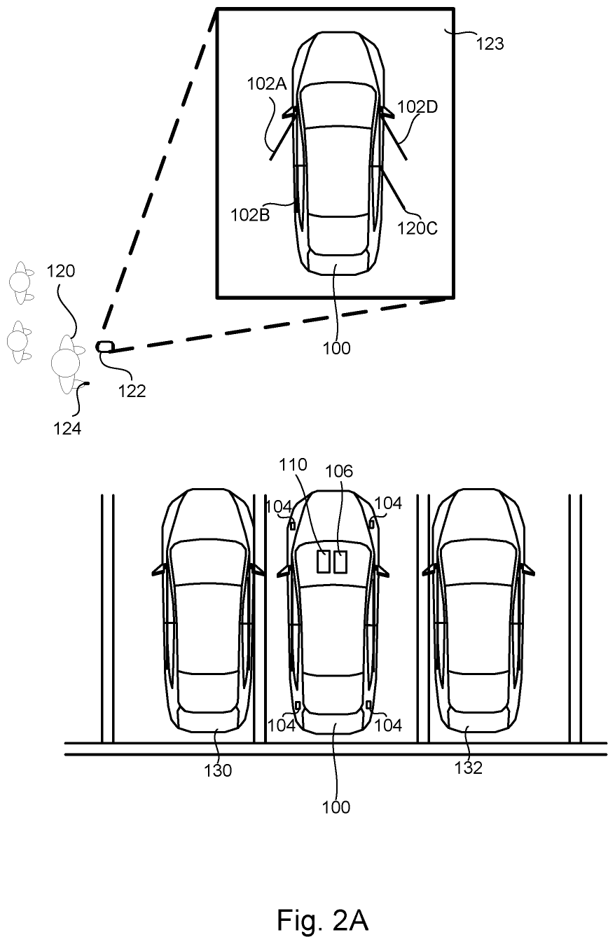

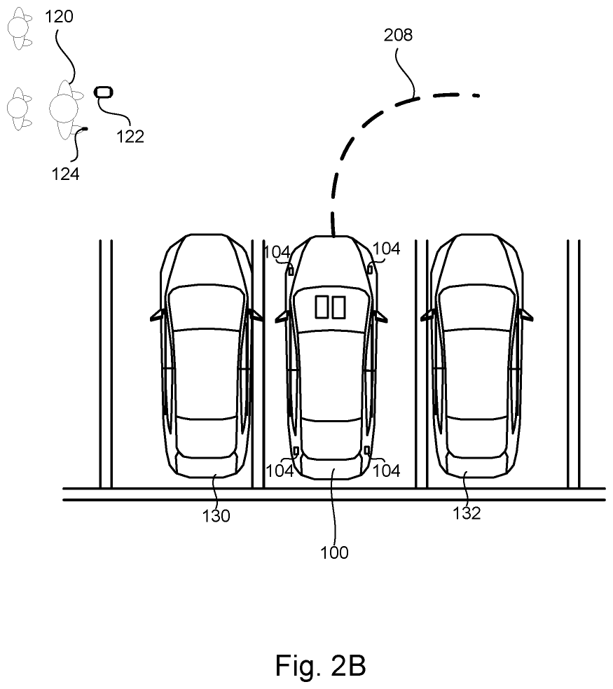

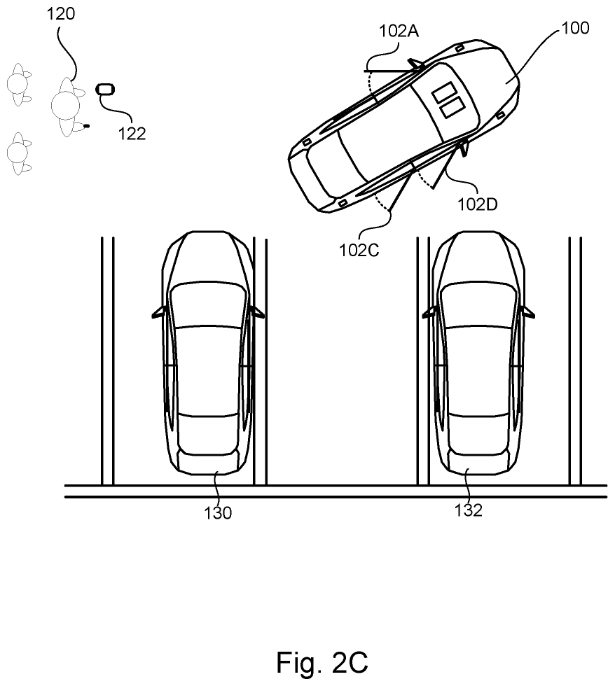

A user 120 may input a selection of one or more vehicle doors via a user interface of the remote computing device 122, which may then be transmitted to processor 110 via the communication system 106. In FIGS. 1A-1C, the user 120 has selected the driver's side door 102A, as shown on the display 123 of remote computing device 122. While FIGS. 1A-1C illustrate a single door selection 102A, FIG. 2A illustrates that in some examples the user 120 may select two or more doors, such as doors 102A, 102C and 102D. The selected door(s) may correspond to the doors that the user intends to use immediately after the park-out operation, either to allow passengers to enter the vehicle, or to place groceries or other objects into the vehicle. For instance, a user 120 returning from a shopping trip may select the driver's side door 102A and the trunk when initiating the park-out operation, because he or she intends to place purchased goods in the trunk of vehicle 100.

Processor 110 may also determine the minimum open door angle corresponding to one or more doors including the selected door(s), wherein the minimum open door angle may correspond to the angle of the door with respect to the vehicle for which an occupant is able to comfortably enter or exit the vehicle. In FIGS. 1A-1C, this may include determining the minimum open door angle of selected door 102A. The open door angle 112 is shown in FIG. 1C.

In some examples, the minimum open door angle may be determined based on a default value (e.g., 45 degrees). This may be defined by the manufacturer, and/or may depend on the make and model of the vehicle, as well as one or more characteristics of the particular door (front vs back, lift gate, etc.).

The minimum open door angle may also be input by a user via user interface of vehicle 100, or via a user interface of the remote computing device 122. The user can specify a particular angle or other value corresponding to the amount that the door opens to allow the user to exit the vehicle.

Further, the minimum open door angle may be set through actuation of the door itself. The user 120 may manually move the door to a particular open position that is comfortable for the user. The vehicle can then store the current angle of the door as the minimum open door angle corresponding to that door for later use.

In some examples, the minimum open door angle for a given door may be determined based on a detected occupant identity. For instance, the vehicle may store one or more profiles or accounts for various vehicle operators or passengers. A first profile may have a first minimum open door angle corresponding to the driver's side front door, and a second profile may have a second, different, minimum open door angle for the same door.

The processor may determine which particular profile to use based on the detection of a key FOB 124, or the particular remote computing device 122 from which the door selection was received. The driver may have the key FOB in his or her pocket, purse, bag, or otherwise have it nearby. The vehicle can then determine an identity or profile corresponding to the key FOB 124, and responsively determine that the minimum open door angle for the door 102A should be set based on the detected identity. Similarly, where the selected door is received from a first remote computing device 122, the vehicle may associate the remote computing device with a particular profile and/or open door angle. Further, in some examples the processor 110 may determine the one or more selected door(s) based on the profile corresponding to the key FOB 124 and/or remote computing device. For instance, where a first user 120 initiates a remote park-out operation, the vehicle may determine that only the front driver's seat is selected based on the source of the park-out operation initiation. And if a different remote computing device was used to initiate the park-out operation, the vehicle may determine that a different door or set of doors is (are) the selected door(s).

In some examples, each selected door may have the same minimum open door angle, while in other examples, one or more doors may have a different angle from the others. Further, in some examples where two or more remote computing devices, key FOBs, or other devices are detected by the vehicle, processor 110 may automatically determine that one or more doors are selected corresponding to the detected device(s).

Processor 110 may also be configured to determine a vehicle path 108 for execution of the remote park-out operation. Vehicle path 108 may be a path along which vehicle 100 is intended to travel to exit the parking spot. The path 108 may be determined based on data gathered by one or more vehicle sensors, such as sensors 104. Further, the path 108 may be determined based on the selected door(s). For instance, if only the driver's side front door 102A is selected as in FIGS. 1A-1C, the path 108 may have a sharper curve to the right since the doors on the right side of the vehicle are not anticipated as being needed to open. However, where one or more doors on each side of the vehicle are selected, the path 108 may instead take a wider curve to position the vehicle 100 further from vehicle 132 at the end of the operation, so as to ensure that the selected doors can open to the required angle.

Further, in some examples the path 108 may be selected or modified based on the selected door(s) to minimize the duration of the remote park-out operation from start until the vehicle reaches a position in which the selected door(s) is (are) accessible. This can beneficially minimize the amount of time passengers must wait outside the vehicle for the remote park-out operation to complete.

Vehicle path 108 is shown and described herein as including a forward driving maneuver out of the parking spot. However, it should be noted that other paths may be possible as well, particularly where the vehicle starts in a different position or orientation, such as reversing backwards out of the parking spot, exiting a parallel parking spot, or any other path or movement that results in the vehicle exiting a parking spot in which one or more doors may be prevented from fully opening.

Processor 110 may then begin executing the remote park-out operation by causing vehicle 100 to travel along the determined path 108. During execution, processor 110 may monitor the relative position of vehicle 100 and/or objects in the environment (e.g., vehicles 132 and 134 in FIGS. 1A-1C).

Then, for each selected door, the processor may determine whether the door can open to its corresponding minimum open door angle or whether it is prevented from doing so by the environment around the vehicle. This can also be understood as the processor determining whether the selected door(s) are accessible or inaccessible, and whether each door has transitioned from one state to the other.

In some examples, where there is only one selected door, processor 110 may be configured to determine whether the selected door has transitioned from being inaccessible to being accessible. This may include first determining that the vehicle door is inaccessible. But if the selected door is determined to be accessible, the vehicle 100 may not move along the path 108, but may instead transmit an alert to the remote computing device indicating that the selected door is accessible.

Where more than one door is selected, it may be the case that one or more of the doors are accessible even before the vehicle 100 begins moving along the path 108. However, the vehicle may nevertheless travel along the path until all selected doors are accessible. Alternatively, if multiple doors are selected, and all selected doors begin as accessible (i.e., the user can open each selected door to a minimum open door angle), the vehicle may provide an alert to the remote computing device indicating as much.

In some examples having multiple selected doors, wherein at least one door is prevented from opening to its corresponding minimum open door angle, the vehicle 100 may travel along the path until the at least one door has transitioned from being inaccessible to being accessible. Thus, a starting condition may include at least one selected door being inaccessible, and an ending condition may include every selected door being accessible.

Thus, during the execution of the park out operation, processor 110 may determine that at least one selected door has transitioned from being inaccessible to being accessible, and that all selected doors are accessible. This determination may be carried out while the vehicle is moving along the path 108. Responsive to this determination, processor 110 may take one or more corresponding actions.

In some examples, processor 110 may responsively pause execution of the remote park-out operation. This can include causing the vehicle to stop moving, turning off one or more vehicle functions or systems, or taking some other appropriate action to stop the execution of the remote park-out procedure.

In some examples, processor 110 may responsively transmit an alert to the remote computing device that transmits the indication of the selected door(s). This alert may indicate to the user that the selected doors are all now accessible, and may prompt the user to control the remote park-out procedure to stop. Under typical remote operation of the vehicle, a continuous input may be required at the remote computing device. For instance, based on safety concerns this may include requiring the user to hold down a button during execution of the remote operation to allow the vehicle to operate. When the processor 110 determines that the selected doors are all accessible, an alert may be presented to the user via the remote computing device that lets the user know it is okay to stop providing the continuous input, allowing the vehicle to stop execution of the remote park-out procedure. This alert may take any suitable form, including for example an audio, visual, haptic, or other type of alert.

In examples where an alert is transmitted to the remote computing device, the vehicle and/or processor may be configured to continue execution of the remote park-out operation until a command is received to stop execution of the operation from the remote computing device. As such, rather than automatically stopping execution of the remote park-out procedure, the processor may provide the user with an opportunity to provide an input command to stop the execution, thereby allowing the user to retain control of the operation.

In some examples, processor 110 may also control vehicle 100 to automatically open one or more of the selected doors. This may be done responsive to determining that the one or more selected door(s) have transitioned from being inaccessible to being accessible, and/or responsive to pausing or stopping execution of the remote park-out operation. In some examples, all of the selected doors may be automatically opened, while in other examples only a subset of the selected doors may be automatically opened.

FIG. 1C illustrates the vehicle 100 in a position along path 108 at which the selected door 102A can open to the minimum open door angle 112. At this position, vehicle 100 may pause execution and optionally automatically open door 102A, to allow user 120 to enter the vehicle.

FIGS. 2A-2C illustrate a second scenario similar to that shown in FIGS. 1A-1C. In FIGS. 2A-2C, three passengers are waiting to enter vehicle 100, and the user 120 has selected three doors 102A, 102C, and 102D. As such, when performing the remote park-out operation there are three doors that have corresponding minimum open door angles.

As can be seen in FIGS. 2A-2C, the user may input the three selected doors via the interface 123 of remote computing device 122. Processor 110 may then determine a vehicle path 208 along which the vehicle will travel to carry out the remote park-out operation. This is shown in FIG. 2B. As noted above, the path 208 may be determined based on the selected doors, such that the path allows the selected doors to open to their corresponding minimum open door angles. This can include taking a wider curve based on the selected doors being on either side of the vehicle as compared to the selected door in FIGS. 1A-1C.

The vehicle 100 then follows the path 208 when executing the remote park-out operation, until it gets to the position shown in FIG. 2C. At this position, all three selected doors can be opened to their corresponding minimum open door angles. As such, when it is determined that the doors are all accessible, the processor may pause execution of the remote parking operation, and/or transmit an alert to the remote computing device 122.

In some examples, during execution of the procedures disclosed herein, the operator may be provided with status updates as the vehicle proceeds to execute the remote parking operation. For instance, the operator may be provided information regarding the current angle to which one or more vehicle doors can open, such as a percentage the door(s) can be opened, a countdown to when the vehicle will pause execution to allow the occupant to enter or exit, a scale of ease of entry or exit based on one or more known characteristics of the occupant, corresponding minimum open door angle, and objects in the environment, and more.

Further, while examples are disclosed herein with reference to a remote park-out operation, it should be understood that the concepts disclosed herein may be applicable to other vehicle operations, and any situation in which an operator may wish to perform an automatic assist or actively controlled maneuver for which the operator may be outside the vehicle to complete the task remotely. This may include operations such as a remote trailer assist maneuver, in which the vehicle automatically moves to assist the operator in attaching a trailer.

FIG. 3 illustrates an example block diagram 300 showing electronic components of vehicle 100, according to some embodiments. In the illustrated example, the electronic components 300 include an on-board computing system 302, an infotainment head unit 320, a communication system 106, sensors 340, electronic control unit(s) 350, and vehicle data bus 360.

The on-board computing system 302 may include a microcontroller unit, controller or processor 110 and memory 312. The processor 110 may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). The memory 312 may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc.). In some examples, the memory 312 includes multiple kinds of memory, particularly volatile memory and non-volatile memory.

The memory 312 may be a non-transitory computer-readable media on which one or more sets of instructions, such as the software for operating the methods of the present disclosure, can be embedded. The instructions may embody one or more of the methods or logic as described herein. For example, the instructions reside completely, or at least partially, within any one or more of the memory 312, the computer-readable medium, and/or within the processor 110 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

The infotainment head unit 320 may provide an interface between vehicle 100 and a user. The infotainment head unit 320 may include one or more input and/or output devices, such as display 322, and user interface 324, to receive input from and display information for the user(s). The input devices may include, for example, a control knob, an instrument panel, a digital camera for image capture and/or visual command recognition, a touch screen, an audio input device (e.g., cabin microphone), buttons, or a touchpad. The output devices may include instrument cluster outputs (e.g., dials, lighting devices), actuators, a head-up display, a center console display (e.g., a liquid crystal display (LCD), an organic light emitting diode (OLED) display, a flat panel display, a solid state display, etc.), and/or speakers. In the illustrated example, the infotainment head unit 320 includes hardware (e.g., a processor or controller, memory, storage, etc.) and software (e.g., an operating system, etc.) for an infotainment system (such as SYNC® and MyFord Touch® by Ford®, Entune® by Toyota®, IntelliLink® by GMC®, etc.). In some examples the infotainment head unit 320 may share a processor with on-board computing system 302. Additionally, the infotainment head unit 320 may display the infotainment system on, for example, a center console display of vehicle 100.

Communications system 106 may include wired or wireless network interfaces to enable communication with one or more internal or external systems, devices, or networks. Communications system 106 may also include hardware (e.g., processors, memory, storage, etc.) and software to control the wired or wireless network interfaces. In the illustrated example, communications system 106 may include a Bluetooth® module, a GPS receiver, a dedicated short range communication (DSRC) module, an Ultra-Wide Band (UWB) communications module, a WLAN module, and/or a cellular modem, all electrically coupled to one or more respective antennas.

The cellular modem may include controllers for standards-based networks (e.g., Global System for Mobile Communications (GSM), Universal Mobile Telecommunications System (UMTS), Long Term Evolution (LTE), Code Division Multiple Access (CDMA), WiMAX (IEEE 802.16m); and Wireless Gigabit (IEEE 802.11ad), etc.). The WLAN module may include one or more controllers for wireless local area networks such as a Wi-Fi® controller (including IEEE 802.11a/b/g/n/ac or others), a Bluetooth® controller (based on the Bluetooth® Core Specification maintained by the Bluetooth® Special Interest Group), and/or a ZigBee® controller (IEEE 802.15.4), and/or a Near Field Communication (NFC) controller, etc. Further, the internal and/or external network(s) may be public networks, such as the Internet; a private network, such as an intranet; or combinations thereof, and may utilize a variety of networking protocols now available or later developed including, but not limited to, TCP/IP-based networking protocols.

Communications system 106 may also include a wired or wireless interface to enable direct communication with an electronic device (such as remote computing device 122). An example DSRC module may include radio(s) and software to broadcast messages and to establish direct connections between vehicles and between vehicles and one or more other devices or systems. DSRC is a wireless communication protocol or system, mainly meant for transportation, operating in a 5.9 GHz spectrum band.

Sensors 340 may be arranged in and around vehicle 100 in any suitable fashion. Sensors 340 may include backup camera 342, and one or more sensors 104 such as those described above. In some examples, backup camera 342 and/or one or more of a RADAR and/or LIDAR may be used to determine a position, speed, and heading of vehicle 100 with respect to an external object, such as nearby cars or structures. This may assist in determining whether or not one or more doors are able to open to a minimum open door angle.

The ECUs 350 may monitor and control subsystems of vehicle 100. ECUs 350 may communicate and exchange information via vehicle data bus 360. Additionally, ECUs 350 may communicate properties (such as, status of the ECU 350, sensor readings, control state, error and diagnostic codes, etc.) to and/or receive requests from other ECUs 350. Some vehicles may have seventy or more ECUs 350 located in various locations around the vehicle communicatively coupled by vehicle data bus 360. ECUs 350 may be discrete sets of electronics that include their own circuit(s) (such as integrated circuits, microprocessors, memory, storage, etc.) and firmware, sensors, actuators, and/or mounting hardware. In the illustrated example, ECUs 350 may include the telematics control unit 352 and the body control unit 354.

The telematics control unit 352 may control tracking of the vehicle 100, for example, using data received by a GPS receiver, communication system 106, and/or one or more sensors 340. The body control unit 354 may control various subsystems of the vehicle. For example, the body control unit 354 may control a trunk latch, windows, power locks, power moon roof control, an immobilizer system, and/or power mirrors, etc.

Vehicle data bus 360 may include one or more data buses, in conjunction with a gateway module, that communicatively couple the on-board computing system 302, infotainment head unit 320, communications module 330, sensors 340, ECUs 350, and other devices or systems connected to the vehicle data bus 360. In some examples, vehicle data bus 360 may be implemented in accordance with the controller area network (CAN) bus protocol as defined by International Standards Organization (ISO) 11898-1. Alternatively, in some examples, vehicle data bus 360 may be a Media Oriented Systems Transport (MOST) bus, or a CAN flexible data (CAN-FD) bus (ISO 11898-7) or a combination of CAN and CAN-FD.

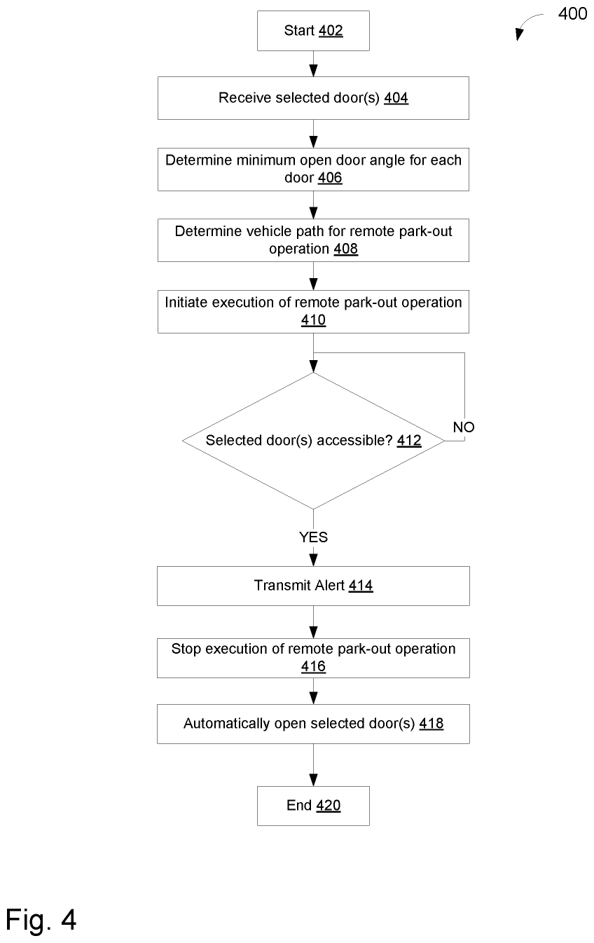

FIG. 4 illustrates a flowchart of an example method 400 according to embodiments of the present disclosure. Method 400 may enable a vehicle user to minimize his or her time outside the vehicle during a remote park-out operation, for example where there is adverse weather, by pausing execution of the remote parking operation at the moment all selected doors become accessible during the operation.

The flowchart of FIG. 4 is representative of machine readable instructions that are stored in memory (such as memory 312) and may include one or more programs which, when executed by a processor (such as processor 110) may cause vehicle 100 to carry out one or more functions described herein. While the example program is described with reference to the flowchart illustrated in FIG. 4, many other methods for carrying out the functions described herein may alternatively be used. For example, the order of execution of the blocks may be rearranged or performed in series or parallel with each other, blocks may be changed, eliminated, and/or combined to perform method 400. Further, because method 400 is disclosed in connection with the components of FIGS. 1-3, some functions of those components will not be described in detail below.

Method 400 may start at block 402. At block 404, method 400 may include receiving an indication of one or more selected doors. The selected door input may be received by the vehicle via a communication system, and may be input by a user via a remote computing device.

At block 406, method 400 may include determining a minimum open door angle for each selected door. As noted above, the minimum open door angle may correspond to the angle between the door and the vehicle at which the user can comfortably enter and exit the vehicle. The minimum open door angle for each door may be a default value, and/or may be set by a user. In some examples, all doors may have the same minimum open door angle, while in other examples one or more doors may have a different angle than the others.

At block 408, method 400 may include determining a vehicle path for a remote park-out operation. The path may be determined such that when the vehicle travels along the path, it avoids running into objects in the environment, and ends in a location at which the driver can enter the vehicle and continue on to his or her destination. In some examples, the path may be determined based on the selected door or doors. For instance, if only the driver's side door is selected, the vehicle path may include a sharp turn that does not allow the passenger side door to open to the minimum open door angle. Alternatively, where the passenger side door is selected by the user, the vehicle path may include a wider curve to allow the passenger side door to become accessible.

At block 410, method 400 may include initiating execution of the remote park-out procedure. This may include the vehicle autonomously traveling along the determined vehicle path to exit the parking spot.

At block 412, method 400 may include determining whether one or more of the selected doors is accessible. This can include gathering data via vehicle sensors that detect the distance between the vehicle (i.e., doors) and objects in the environment. If the doors are able to open to their corresponding minimum open door angles without running into or hitting any objects in the environment, they may be deemed accessible.

If all the selected doors are accessible, method 400 may include transmitting an alert at block 414. The alert may be transmitted to the remote computing device of the user that started the remote park-out operation by selecting one or more vehicle doors.

At block 416, method 400 may include stopping or pausing execution of the remote park-out operation. This may include causing the vehicle to brake or cease moving along the path. Then at block 418, method 400 may include automatically opening one or more of the selected doors. In some examples this may include opening the doors to their corresponding minimum open door angles, which may be different from each other. Method 400 may then end at block 420.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle comprising:
a communication system;
doors;
sensors; and
a processor configured to:
receive an indication of a selected door via the communication system;
determine a vehicle path for a remote park-out operation; and
during execution of the remote park-out operation, determine using the sensors that the selected door transitioned from being inaccessible to being accessible.

2. The vehicle of claim 1, wherein the processor is further configured to:
responsive to determining that the selected door transitioned from being inaccessible to being accessible, pause execution of the remote park-out operation.

3. The vehicle of claim 1, wherein the processor is further configured to:
responsive to determining that the selected door transitioned from being inaccessible to being accessible, transmit an alert to a remote computing device.

4. The vehicle of claim 3, wherein the processor is further configured to continue execution of the remote park-out operation until a command is received to stop execution of the remote park-out operation from the remote computing device.

5. The vehicle of claim 1, wherein the processor is further configured to:
responsive to determining that the selected door transitioned from being inaccessible to being accessible, automatically open the selected door.

6. The vehicle of claim 1, wherein the indication comprises a plurality of selected doors, and wherein the processor is further configured to:
during execution of the remote park-out operation, determine that (i) one or more of the plurality of selected doors has transitioned from being inaccessible to being accessible, and (ii) all of the plurality of selected doors are accessible.

7. The vehicle of claim 1, wherein the processor is further configured to determine that the selected door has transitioned from being unable to open to a minimum open door angle to being able to open to the minimum open door angle.

8. The vehicle of claim 7, wherein the processor is further configured to determine the minimum open door angle corresponding to the selected door.

9. The vehicle of claim 8, wherein the processor is further configured to determine the minimum open door angle corresponding to the selected door based on a characteristic of a remote computing device from which the indication of the selected door was received.

10. The vehicle of claim 1, wherein the processor is further configured to determine the vehicle path for the remote park-out operation based on the selected door.

11. A method comprising:
receiving, by a communication system of a vehicle, an indication of a selected door of the vehicle;
determining a vehicle path for a remote park-out operation; and
during execution of the remote park-out operation, determining using sensors of the vehicle that the selected door transitioned from being inaccessible to being accessible.

12. The method of claim 11, further comprising:
responsive to determining that the selected door transitioned from being inaccessible to being accessible, pausing execution of the remote park-out operation.

13. The method of claim 11, further comprising:
responsive to determining that the selected door transitioned from being inaccessible to being accessible, transmitting an alert to a remote computing device.

14. The method of claim 13, further comprising:
continuing execution of the remote park-out operation until a command is received to stop execution of the remote park-out operation from the remote computing device.

15. The method of claim 11, further comprising:
responsive to determining that the selected door transitioned from being inaccessible to being accessible, automatically opening the selected door to a minimum open door angle.

16. The method of claim 11, further comprising:
receiving a plurality of selected doors via the communication system; and
during execution of the remote park-out operation, determine that (i) one or more of the plurality of selected doors has transitioned from being inaccessible to being accessible, and (ii) all of the plurality of selected doors are accessible.

17. The method of claim 11, wherein determining that the selected door has transitioned from being inaccessible to being accessible comprises:
determining that the selected door has transitioned from being unable to open to a minimum open door angle to being able to open to the minimum open door angle.

18. The method of claim 17, further comprising:
determining the minimum open door angle corresponding to the selected door.

19. The method of claim 18, further comprising:
determining the minimum open door angle corresponding to the selected door based on a characteristic of a remote computing device from which the indication of the selected door was received.

20. The method of claim 11, further comprising:
determining the vehicle path for the remote park-out operation based on the selected door.
